(19) United States
(12) Patent Application Publication
(10) Pub. No.: US 2024/0240461 A1
(43) Pub. Date: Jul. 18, 2024

(54) MINERAL SURFACE COATING FOR A ROOF SYSTEM TO ABSORB CARBON DIOXIDE

(71) Applicant: The Garland Company, Inc., Independence, OH (US)

(72) Inventors: David S. Finley, Macedonia, OH (US); Julie Geyer, Brecksville, OH (US)

(21) Appl. No.: 18/414,232

(22) Filed: Jan. 16, 2024

Related U.S. Application Data
(60) Provisional application No. 63/438,976, filed on Jan. 13, 2023.

(51) Int. Cl. E04D 1/28; C08K 3/36; E04D 7/00

(52) U.S. Cl. CPC E04D 1/28; C08K 3/36; E04D 7/005

(57) ABSTRACT

A roofing and/or siding materials, and more particularly to improved roofing and/or siding materials having carbon dioxide absorbing properties.

### REFERENCED APPLICATIONS

The present application claims priority to U.S. Provisional Application Ser. No. 63/438,976 filed Jan. 13, 2023, which is fully incorporated herein by reference.

### FIELD OF DISCLOSURE

The present disclosure is directed to a roofing and/or siding material, and more particularly to improved roofing and/or siding materials having carbon dioxide absorbing properties.

### INCORPORATION BY REFERENCE

U.S. Pat. Nos. 2,379,358; 3,255,031; 3,479,201; 3,528,842; 4,120,132; 4,288,959; 4,478,869; 5,088,259; 5,474,838; 5,540,971; 5,573,810; 5,695,373; 5,813,176; 5,965,626; 6,110,846; 6,194,519; 6,207,593; 6,296,912; 6,296,921; 6,341,462; 6,360,511; 10,626,615; 10,597,555; 11,433,366; 11,427,507; 11,371,244; and 11,453,614 are incorporated herein by reference to illustrate various types of roofing and/or siding systems on which the granular material of the present disclosure can be used, to also illustrate various manufacturing techniques for making such roofing and/or siding systems, and/or to further illustrate various types of prior art granules.

### BACKGROUND OF THE DISCLOSURE

Weather resistant granules of various hues, embedded on the surface of various types of roofing and/or siding, have been used extensively to provide an aesthetically pleasing color to such surfaces. In North America, asphalt-based roofing materials are a popular medium for covering roofs of homes and other structures. Asphalt-based roofing materials typically come in shingle or roll form, the shingle being the more widely used material. A typical asphalt shingle has an asphalt substrate and a multitude of granules placed thereon. The granules are generally embedded in the asphalt coating on the surface of an asphalt-impregnated base material such as roofing felt. The granules, which are embedded in one surface of the asphalt-impregnated and/or asphalt-coated fiber sheet material, form a coating to provide an inherently weather-resistant, fire-resistant, and/or decorative exterior surface.

The granules employed for roofing and siding are generally derived from a hard mineral base rock such as slate, basalt or nephelite. The granules are typically ground to a particle size of about 10 to about 35 US mesh. These granules can optionally be coated with a pigment composition having a thickness of about 4 to about 18 microns. Colored roofing granules are typically prepared by heating mineral rock granules of about 12-40 US mesh up to approximately 1000° F.

In these applications, the aggregate is between ⅛-¾ in. in diameter and broadcast manually or mechanically onto an adhesive consisting of either hot asphalt or cold adhesive that may or may not be asphalt based, may or may not be solvent based, and may or may not be moisture cured.

As the population of the World has increased and has become more industrialized, the amount of greenhouse gasses has increased in the atmosphere. There are concerns that if the quantity of greenhouse gasses in the atmosphere are not controlled, the effects of global warming from such greenhouse gasses could be catastrophic to many individuals. Various efforts are ongoing to deal with this potentially dangerous issue.

In urban areas where large qualities of carbon dioxide are produced, there is a need for a simple way to reduce the amount of carbon dioxide released into the atmosphere. The relatively large areas and long lifespans of roofs may be advantageous for absorbing CO₂ from the air over its lifetime.

### SUMMARY OF DISCLOSURE

The present disclosure relates to roofing and/or siding materials and a method of making and using such materials to reduce greenhouse gasses in the environment, and more particularly to a granular material and method of applying the granular material to the surface of a roofing and/or siding materials resulting in the granular material absorbing carbon dioxide during the partial or full life of the roofing and/or siding materials on a structure. The present disclosure is applicable to all types of roofing and/or siding materials including, but not limited to, shingles, cap sheet roll, modified bitumen, foam roofing, built-up roofing (BUR), metal roofing and/or siding, plastic roofing and/or siding, flood coat and gravel systems, and wood roofing and/or siding. As can be appreciated, the present disclosure has a broader scope in that the granular material can be used in other applications such as, but not limited to, streets, sidewalks, parking lots, driveways, runways, steps, landscape stones, statues, and other types of structures.

Roofing systems having a bitumen- or asphalt-based water-resistant layer are well known. A layer of granules is typically applied to the surface of the bitumen- or asphalt-based layer during manufacturing or, in the case of a flood coat and gravel system, during installation. The granules are also used to alter the appearance of the roof surface, provide weather protection to the roof surface, improve the fire rating of the roofing surface, reduce photo degradation of the modified bitumen roofing surface, improve impact resistance of the roofing surface (e.g., hail damage, foot traffic), improve slip resistance of the roofing surface, and/or provide an anti-blocking effect when the roofing material is rolled after manufacture. As a result, it is now common to embed a layer of roofing granules in an exposed surface of such a roofing system, whether that system be discrete membrane panels such as shingles, rolled membrane products (e.g., modified bitumen, cap sheet roll), or formed in place membranes, such as are formed by mopping liquid bitumen- or asphalt-based roofing material atop a roofing base.

Roofing and/or siding shingles and cap sheet roll and/or siding usually employ a web of fibrous base material. The base material typically is a nonwoven fabric such as, but not limited to, felt (organic, glass fiber, polyester, polypropylene, etc.), fiberglass, or similar materials, which are coated with a bituminous composition such as, but not limited to, bitumen, modified bitumen, tars, pitches, asphalt, and the like. The bituminous composition can include a filler such as, but not limited to, inorganic fillers or mineral stabilizers, organic materials such as polymers, recycled streams, or ground tire rubber, slate flour, and/or powdered limestone. Granules are then pressed into the layer of bituminous composition while it is in a warm, softened condition. Upon cooling, the granules remain attached as a surface layer. Finely divided materials such as mica flakes, talc, silica dust or the like may be made adherent to the non-weather exposed surface of the shingle to prevent sticking of the adjacent layers of the material in packages. Examples of shingles are disclosed in U.S. Pat. Nos. 6,194,519; 6,296,912; and 6,341,462, which are fully incorporated herein by reference.

Modified bitumen incorporates the use of a composite fabric that is impregnated with a bituminous composition. The composite fabric typically includes a layer of woven or nonwoven material connected to a layer of low shrinkage warp strands and/or a layer of low shrinkage weft strands. The layers are typically stitched or knitted together, and the resultant fabric may be coated with a resin or sizing to prevent slippage between the several layers of the fabric and impart a measure of stiffness to the fabric. The fibers comprising the warp stands, the weft strands, and/or the woven or nonwoven material can include fibers selected from a variety of sources such as, but not limited to, natural materials, polymeric materials, inorganic materials, and combinations thereof. Non-limiting examples of such fibers include polycrystalline fibers, fiberglass, thermoplastic fiber filaments (e.g., polyamide fibers of poly (p-phenylene terephthalate), poly (o-phenylene terephthalamide), ultra-low shrink polyester), cotton, cellulose, natural rubber, flax, ramie, hemp, sisal, wool, linen (flax), paper, wood pulp, polyamides, polyesters, acrylics, polyolefins, polyurethanes, vinyl polymers, and derivatives and mixtures thereof. The fibers can be continuous filaments, fibers, strands, and/or yard. Like shingles, the composite fabric is coated with a bituminous material and then coated with granules that are then pressed into the layer of bituminous material while it is in a warm, softened condition. Examples of modified bitumen are disclosed in U.S. Pat. Nos. 5,474,838; 5,540,971; 5,695,373; and 6,296,921, which are fully incorporated herein by reference.

Built-up roofing (BUR) systems generally comprise a substantially rigid deck covered with a membrane comprising one or more layers of bituminous composition impregnated felt having a separately applied coating of bituminous composition on top of each layer of felt with a protective layer of granules broadcast and embedded in and covering the top bituminous composition. The granules are typically applied on the surface in bulk between 10-400 lbs./100 sq. ft. (and all values and ranges therebetween), a practice referred to as “to rejection”. BUR is used primarily on commercial buildings which have flat or low-slope roofing systems. Its popularity arises from its relatively low cost combined with its effectiveness as a water repellant membrane and its durability. Examples of BUR are disclosed in U.S. Pat. Nos. 6,360,511; 6,207,593; and 6,110,846, which are fully incorporated herein by reference.

Foam roofing and/or siding also are used primarily on commercial buildings which have flat or low-slope roofing systems; however, other types of surfaces can be used. The polymer foam is typically sprayed or mopped on the roof surface and granules are applied to the polymer surface prior to the polymer fully curing. Like BUR, the granules are applied to the foam surface in bulk. Foam roofing systems may also include a layer of material (i.e., felt, board, etc.) between the foam and the granules. Examples of foam roofing are disclosed in U.S. Pat. Nos. 5,088,259; 5,813,176; and 5,965,626, which are fully incorporated herein by reference.

Metal, plastic, and wood roofing and/or siding have also been coated with granules to provide texture, color, and/or improved durability. Typically, the granules are adhered to the metal, plastic and wood roofing, and/or siding by the use of an adhesive such as, but not limited to, polymer adhesives, glue, bitumen, asphalt, etc. Examples of metal, plastic, and wood roofing and/or siding are disclosed in U.S. Pat. Nos. 4,120,132 and 4,288,959, which are fully incorporated herein by reference.

The prior art granules that are commonly applied to the roofing and/or siding surfaces are generally inert granules. Many types of prior art granules are coated with a paint, polymer, metallic, or ceramic coating to provide reflectance. The present disclosure is directed to the use of granules that are partially or fully formed of olivine and/or serpentinite. The granules in accordance with the present disclosure are generally not coated with a material that inhibits or prevents interaction of the olivine and/or serpentinite in the granule with the carbon dioxide in the surrounding atmosphere. Olivine is a magnesium iron silicate (Mg, Fe)₂SiO₄ where the magnesium and iron concentrations can replace each other in all proportions. Serpentinite is a hydrous magnesium iron phyllosilicate ((Mg,Fe)₃Si₂O₅(OH)₄) mineral. The common types of serpentinite are antigorite, bowenite, gymnite, picrolite, lizardite, and chrysotile. The olivine and/or serpentinite may contain minor amounts of other elements such as, but not limited to, chromium, manganese, cobalt, and/or nickel. Olivine and/or serpentinite is able to absorb and store CO₂ through the following chemical reaction with the magnesium fraction of the mineral: Mg₂SiO₄(s)+4CO₂(g)+2HO(l)→2Mg²⁺+4CO₃²⁻(aq)+H₄SiO₂(aq). The olivine and/or serpentinite can be used as the partial (e.g., 0.1-99.9 wt. % and all values and ranges therebetween) or the only gravel component in a “flood coat and gravel” roofing system wherein the olivine and/or serpentinite granules or olivine and/or serpentinite containing granules are broadcast into hot asphalt or cold applied material. The olivine and/or serpentinite granules or olivine- and/or serpentinite-containing granules can also or alternatively be used in a modified bitumen membrane. In either application, the olivine and/or serpentinite granules or olivine- and/or serpentinite-containing granules will be partially or fully be located on the surface of the roofing system to absorb CO₂ from the surrounding atmosphere during the partial or full life of the roof (e.g., 5-50 years). The olivine and/or serpentinite granules or olivine- and/or serpentinite-containing granules on the roofing system can potentially absorb sufficient qualities of surrounding environment CO₂ during the work life of the roof to create a net carbon negative building; however, this is not required. In one non-limiting embodiment, the granules in accordance with the present disclosure that are partially or fully formed of olivine and/or serpentinite are not coated or only partially coated (e.g., 0.001-50% and all values and ranges therebetween of the outer surface of the granule is coated) with a material that inhibits or prevents interaction of the olivine and/or serpentinite in the granule with the carbon dioxide in the surrounding atmosphere. In another non-limiting embodiment, the granules in accordance with the present disclosure are formed of 10-100% (and all values and ranges therebetween) of olivine and/or serpentinite. One ton of olivine and/or serpentinite has the potential to absorb between 0.9-1.1 tons of CO₂. When the olivine and/or serpentinite is used as an aggregate broadcast as part of a flood coat and gravel system or as a mineral surfacing on a modified bitumen membrane, the granules that are formed of or include olivine and/or serpentinite have the potential to absorb an estimated 32-38 lbs. of CO₂ per 100 sq. ft, of surface area of the roofing and/or siding system.

In another and/or alternative non-limiting aspect of the present disclosure, the olivine and/or serpentinite granules or olivine- and/or serpentinite-containing granules generally have a size of at least 200 microns (e.g., 200 microns to 25 mm and all values and ranges therebetween; 450 microns to 5 mm, etc.). The olivine and/or serpentinite granules or olivine- and/or serpentinite-containing granules that are used on “flood coat and gravel” roofing system can be broadcast at a rate of at least 100 lbs./100 sq. ft. (e.g., 100-800 lbs./100 sq. ft. and all values and ranges there between; 300-400 lbs./100 sq. ft., etc.) onto the roof surface that has been flood coated with asphalt, coal tar, bitumen, or a “cold applied” product. As can be appreciated, the size of the olivine and/or serpentinite granules or olivine- and/or serpentinite-containing granules is non-limiting. The olivine and/or serpentinite granules or olivine- and/or serpentinite-containing granules that are used on shingles or a modified bitumen rolled good are generally applied to the modified asphalt while it is still warm to form a continuous surface of olivine and/or serpentinite granules or olivine- and/or serpentinite-containing granules on the top of the membrane; however, this is not required. The olivine and/or serpentinite granules or olivine- and/or serpentinite-containing granules that are used on foam roofing and/or siding, and/or on metal, plastic, and wood roofing and/or siding can be secured to such materials by use of an adhesive, or the like. In one non-limiting embodiment, the olivine and/or serpentinite granules or olivine-and/or serpentinite-containing granules that are applied to a roof or roofing/siding material cover 5-100% (and all values and ranges therebetween) of the top surface of the roof or roofing/siding material.

In another and/or alternative non-limiting aspect of the present disclosure, the olivine and/or serpentinite granules or olivine- and/or serpentinite-containing granules are used to cover at least 50% (e.g., 50-100% and all values and ranges therebetween) of the top surface of the roofing and/or siding system. In one non-limiting embodiment, the roofing and/or siding system can optionally be coated by a multiple granular coating method. The multiple granular coating method (when used) includes the steps of first applying a granular material having a first average size of material, and secondly applying another layer of granular material having a second average size of material, wherein the first average size is greater than the second average size. The multiple granular coating method can be used on any type of roofing and/or siding system (e.g., metal roofing, plastic roofing, wood roofing, BUR, and foam roofing, etc.). In another non-limiting embodiment, the coverage percentage of the granules on the top surface of the roofing and/or siding system is at least 60% (e.g., 60-100% and all values and ranges therebetween).

In another and/or alternative non-limiting aspect of the present disclosure, the olivine and/or serpentinite granules or olivine- and/or serpentinite-containing granules form a mixture with other types of granules that do not include olivine and/or serpentinite to form the top surface of the roofing and/or siding system. The granules that do not include olivine and/or serpentinite can include granules derived from a hard mineral base rock such as slate, basalt, or nephelite, and wherein such granules may or may not be coated. These granules that do not include olivine and/or serpentinite can have a particle size of about 10 to about 35 US mesh (and all values and ranges therebetween).

It is one non-limiting object of the present disclosure to provide an improved roofing and/or siding system that includes olivine and/or serpentinite granules or olivine and/or serpentinite containing granules.

Another and/or alternative non-limiting object of the present disclosure is the provision of a roofing and/or siding system that has improved environmental benefits in that such roofing and/or siding system can absorb CO₂.

Another and/or alternative non-limiting object of the present disclosure is the provision of a roofing and/or siding system includes, but is not limited to, shingles, cap sheet roll roofing, modified bitumen, foam roofing, built-up roofing (BUR), metal roofing and/or siding, plastic roofing and/or siding, flood coat and gravel systems, and wood roofing and/or siding, and which roofing and/or siding system includes olivine and/or serpentinite granules or olivine and/or serpentinite containing granules on the top surface of the roofing and/or siding system.

Another and/or alternative non-limiting object of the present disclosure is the provision of a roofing and/or siding system that includes a bitumen-based or asphalt-based water-resistant layer and olivine and/or serpentinite granules or olivine and/or serpentinite containing granules on the top surface of the bitumen-based or asphalt-based water-resistant layer.

Another and/or alternative non-limiting object of the present disclosure is the provision of a roofing and/or siding system that includes olivine and/or serpentinite granules or olivine and/or serpentinite containing granules that have a size of at least 200 microns (e.g., 200 microns to 6 mm and all values and ranges therebetween; 450 microns to 1 mm, etc.).

Another and/or alternative non-limiting object of the present disclosure is the provision of a roofing and/or siding system that includes olivine and/or serpentinite granules or olivine and/or serpentinite containing granules that cover 5-100% of the top surface of the roof or roofing/siding material.

Another and/or alternative non-limiting object of the present disclosure is the provision of a roofing and/or siding system that includes olivine and/or serpentinite granules or olivine and/or serpentinite containing granules, and wherein the olivine and/or serpentinite granules or olivine and/or serpentinite containing granules constitute 0.1-100 wt. % (and all values and ranges therebetween) of the granules on the top surface of the roof or roofing/siding material.

Another and/or alternative non-limiting object of the present disclosure is the provision of a roofing and/or siding system that is coated by a multiple granular coating method wherein a granular material having a first average size of material is applied as one layer and another layer of granular material having a second average size of material is applied, and wherein one or both of the granular layers includes olivine and/or serpentinite granules or olivine and/or serpentinite containing granules.

Another and/or alternative non-limiting object of the present disclosure is the provision of a roofing and/or siding system that is commercially feasible and economical to manufacture.

Another and/or alternative non-limiting object of the present disclosure is the provision of a roofing and/or siding system that includes granules that can be applied to a variety of roofing and/or siding systems.

Another and/or alternative non-limiting object of the present disclosure is the provision of a roofing and/or siding system that is coated by a multi-coating process.

Another and/or alternative non-limiting object of the present disclosure is the provision of a roofing and/or siding system that includes a) a roofing and/or siding material, and b) granules; at least a portion of the granules are secured to a top surface of the roofing and/or siding material; at least a portion of the granules are partially or fully formed of a CO₂ absorbing mineral material that includes magnesium, iron and silicate.

Another and/or alternative non-limiting object of the present disclosure is the provision of a roofing and/or siding system wherein the CO₂ absorbing mineral material includes olivine and/or serpentinite.

Another and/or alternative non-limiting object of the present disclosure is the provision of a roofing and/or siding system wherein the CO₂ absorbing mineral material has an average particle size of 0.2-25 mm.

Another and/or alternative non-limiting object of the present disclosure is the provision of a roofing and/or siding system wherein the CO₂ absorbing mineral material covers 5-100% of the top surface of the roofing and/or siding material.

Another and/or alternative non-limiting object of the present disclosure is the provision of a roofing and/or siding system wherein the roofing and/or siding material includes a) wood base sheet, b) a plastic base sheet, c) a foam base sheet, d) a metal sheet, e) a shingle, f) a cap sheet, g) a modified bitumen membrane, h) a bitumen membrane, i) an asphalt membrane, j) polyurethane layer, k) an asphalt layer, l) a bitumen layer, m) a built-up roofing (BUR) layer, or n) an adhesive layer (e.g., polyurethane adhesive, asphalt adhesive, bitumen adhesive, epoxy adhesives, polyimide adhesives, polyvinyl acetate adhesive, cyanoacrylate adhesive, hot melt adhesive, etc.) on a roof or siding substrate. When the roofing and/or siding material includes a wood base sheet, the type and thickness of the wood sheet is non-limiting. Generally an adhesive material (e.g., polyurethane adhesive, asphalt adhesive, bitumen adhesive, epoxy adhesives, polyimide adhesives, polyvinyl acetate adhesive, cyanoacrylate adhesive, hot melt adhesive, etc.) on the top surface of the wood base sheet is used to partially for fully secure one or more granules to the top surface of the wood base sheet. The thickness of the adhesive material is non-limiting. When the roofing and/or siding material includes a metal base sheet, the type, composition and thickness of the metal sheet is non-limiting. Generally an adhesive material (e.g., polyurethane adhesive, asphalt adhesive, bitumen adhesive, epoxy adhesives, polyimide adhesives, polyvinyl acetate adhesive, cyanoacrylate adhesive, hot melt adhesive, etc.) on the top surface of the metal base sheet is used to partially for fully secure one or more granules to the top surface of the metal base sheet. The thickness of the adhesive material is non-limiting. When the roofing and/or siding material includes a plastic base sheet, the type, composition and thickness of the plastic sheet is non-limiting. Generally an adhesive material (e.g., polyurethane adhesive, asphalt adhesive, bitumen adhesive, epoxy adhesives, polyimide adhesives, polyvinyl acetate adhesive, cyanoacrylate adhesive, hot melt adhesive, etc.) on the top surface of the plastic base sheet is used to partially for fully secure one or more granules to the top surface of the plastic base sheet. The thickness of the adhesive material is non-limiting. When the roofing and/or siding material includes a foam base sheet (e.g., polystyrene foam, polyurethane foam, polyethylene foam, polyvinyl chloride (PVC) foam, neoprene foam, ethylene propylene diene monomer (EPDM) foam, etc.), the type, composition and thickness of the metal sheet is non-limiting. Generally an adhesive material (e.g., polyurethane adhesive, asphalt adhesive, bitumen adhesive, epoxy adhesives, polyimide adhesives, polyvinyl acetate adhesive, cyanoacrylate adhesive, hot melt adhesive, etc.) on the top surface of the foam base sheet is used to partially for fully secure one or more granules to the top surface of the foam base sheet. The thickness of the adhesive material is non-limiting.

Another and/or alternative non-limiting object of the present disclosure is the provision of a roofing and/or siding system wherein the roofing and/or siding material is i) a shingle, ii) a cap sheet, iii) a modified bitumen membrane, iv) a bitumen membrane, or v) an asphalt membrane, the roofing and/or siding material includes a layer of reinforcement material.

Another and/or alternative non-limiting object of the present disclosure is the provision of a roofing and/or siding system wherein all of the granules a) are fully formed of olivine and/or serpentinite, and/or b) include olivine and/or serpentinite.

Another and/or alternative non-limiting object of the present disclosure is the provision of a roofing and/or siding system wherein a portion of the granules are formed of or include olivine and/or serpentinite and a portion of the granules are absent olivine and/or serpentinite.

Another and/or alternative non-limiting object of the present disclosure is the provision of a roofing and/or siding system wherein the granules are a mixture of a) granules fully formed of olivine and/or serpentinite and granules that are partially formed of olivine and/or serpentinite, b) granules fully formed of olivine and/or serpentinite and granules that are formed of materials other than olivine and/or serpentinite, c) granules partially formed of olivine and/or serpentinite and granules that are formed of materials other than olivine and/or serpentinite, or d) granules fully formed of olivine and/or serpentinite, granules that are partially formed of olivine and/or serpentinite, and granules that are formed of materials other than olivine and/or serpentinite.

Another and/or alternative non-limiting object of the present disclosure is the provision of a roofing and/or siding system wherein siid granules that are partially or fully formed of olivine and/or serpentinite are not fully coated with a material that inhibits or prevents CO₂ from being absorbed in the olivine and/or serpentinite.

Another and/or alternative non-limiting object of the present disclosure is the provision of a roofing and/or siding system wherein the top surface of the roofing and/or siding material includes an asphalt and/or bitumen surface; a plurality of the granules are at least partially embedded in the asphalt and/or bitumen surface. Another and/or alternative non-limiting object of the present disclosure is the provision of a roofing and/or siding system wherein wherein the roofing and/or siding system is a flood coat and gravel system; the granules on the flood coat and gravel system are from 1/16 inch to 1 inch in diameter; the granules are broadcast onto an adhesive surface on the top surface of the roofing and/or siding material; the granules are applied to the top surface of the roofing and/or siding material at a coverage of 100-400 lbs./100 square feet.

These and other objects and advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a side sectional view of a roofing and/or siding system that includes olivine and/or serpentinite granules or olivine- and/or serpentinite-containing granules; and

FIG. 2 is a side sectional view of another roofing and/or siding system that includes olivine and/or serpentinite granules or olivine- and/or serpentinite-containing granules.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

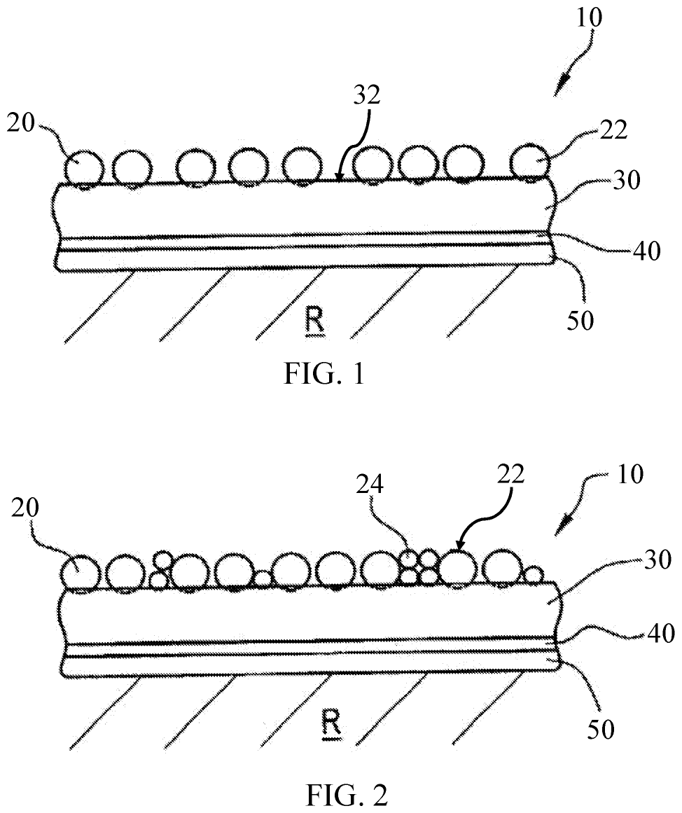

Referring now to the drawings wherein the showings are for the purpose of illustrating non-limiting embodiments of the disclosure only and not for the purpose of limiting same, FIGS. 1-2 illustrate various non-limiting embodiments of the roofing and/or siding system in accordance with the present disclosure.

The roofing and/or siding system in accordance with the present disclosure that includes granules that are partially or fully formed of olivine and/or serpentinite can be shingles, cap sheet roll, modified bitumen, foam roofing, built-up roofing (BUR), metal roofing and/or siding, plastic roofing and/or siding, flood coat and gravel systems, and wood roofing and/or siding. When a bituminous composition is used, the bituminous composition is typically bitumen, cold tar, and/or asphalt; however, other or additional constituents known in the art can be used. The thickness of the bituminous composition is selected to meet the desired end use of the roofing and/or siding system.

Referring now to the FIGS. 1-2, there is illustrated a non-limiting shingle, cap sheet roll, or modified bitumen roofing sheet 10 that is secured to a roof, roof substrate (e.g., base sheets), or subroof R by any suitable arrangement. As will be appreciated, the other types of roofing systems (e.g., foam roofing, built-up roofing (BUR), metal roofing and/or siding, plastic roofing and/or siding, flood coat and gravel systems, and wood roofing and/or siding) that can include the granules that are partially or fully formed of olivine and/or serpentinite will not be discussed in detail herein; however, many or all of the features and concepts for using granules that are partially or fully formed of olivine and/or serpentinite on the shingle, cap sheet roll, or modified bitumen roofing sheet 10 as illustrated in FIGS. 1-2 and as described in more detail below will be understood by one skilled in the art as being applicable and useful on such other types of roofing systems.

As illustrated in FIGS. 1-2, the shingle, cap sheet roll, or modified bitumen roofing sheet 10 includes a bitumen- or asphalt-based material 30, 50, an optional reinforcement material 40 therebetween, and granules 20, 22, 24. Reinforcement material 40 (when used) is typically a felt or fiberglass material; however, other materials can be used (e.g., carbon fibers, glass fibers, aramid fibers [Kevlar™, Twaron™, etc.], boron fibers, hemp fibers, basalt fibers, nylon fibers, Dyneema™ fibers, Zylon™ fibers, etc.). Reinforcement material 40 can optionally be fully or partially embedded in one or both of the bitumen- or asphalt-based layers 30, 50. As can be appreciated, the shingle, cap sheet roll, or modified bitumen roofing sheet 10 can include only a single bitumen- or asphalt-based layers or more than two bitumen-based or asphalt-based layers. Granules 20, 22, 24 can be partially embedded and secured on top surface 32 of bitumen- or asphalt-based material 30. The composition of granules 20 and 22 can be the same or different. The composition of granules 24 can be the same or different from the composition of granule 20 and/or granule 22. A portion or all of granules 20, 22, 24 are partially or fully formed of olivine and/or serpentinite. A portion of the granules 20, 22, 24 can optionally be typical granules used in roofing materials such as granules that are derived from a mineral base rock such as greenstone, greystone, nephylene syenite, gravel slate, gannister, granite, quartzite, andosite, rhyolite and the like. Such granules can be optionally coated to color the granules and/or provide the granules with antimicrobial resistance.

As illustrated in FIGS. 1-2, granules 20 and 22 and granules 24 are illustrated as spherical and have similar sizes. In practice, the granules have a variety of different shapes and not all of the granules are the same size. One common size of granules is No. 11 grade particles. No. 11 grade particles are known in the industry to have a particle range of about 8×40 US mesh having an average mesh size of about 19 US mesh (i.e. 937 mm sieve designation). As can be appreciated, the granule can have other or additional sizes.

Referring now to FIG. 2, the top surface 32 of the top layer of the bitumen- or asphalt-based material 30 includes two different sizes of granules 24, 20, and 22. Most of granules are illustrated as being partially embedded and secured in top surface 32 of the bitumen- or asphalt-based material 30. As can be appreciated, some of granules may be fully embedded in bitumen- or asphalt-based material 30 and/or not embedded in bitumen- or asphalt-based material 30. The size of granules 24 is illustrated as having an average size which is less than the average size of granules 20, 22. The smaller granules 24 can occupy the spaces between larger granules 20, 22, thereby increasing the amount of coverage of top surface 32 of the bitumen- or asphalt-based material 30. One non-limiting example for shingles, cap sheet roll, or modified bitumen roofing and/or siding systems is to use No. 11 grade particles or No. 14 grade particles (particle range of 12-40 US mesh and an average US mesh size of 22 US mesh (i.e. 754 mm sieve designation)) for granules 20, 22 and to use 28×48 designated particles having an average US mesh size of about 50 US mesh (i.e. 304 mm sieve designation) for granules 24. As can be appreciated, other sized particles can be used for granules. For BUR roofing and/or siding systems, one non-limiting example is to use a particle range of 2.5-9 US mesh having an average US mesh size of 3.5 US mesh for granules 20, 22 and No. 11 grade particles for granules 24. As can be appreciated, other sized particles can be used for the granules. It is not uncommon that the mean diameter of the granules for BUR roofing and/or siding systems exceed 1 inch. Granules larger than 0.25 in. in diameter are commonly referred to as gravel.

One or more or all of granules 20, 22, 24 can be partially or fully formed of olivine and/or serpentinite. The granules that are partially or fully formed of olivine and/or serpentinite are generally not coated with a material that inhibits or prevents interaction of the olivine and/or serpentinite in the granule with the carbon dioxide in the surrounding atmosphere. In one non-limiting embodiment, one or more or all of granules 20, 22, 24 are fully or partially formed of olivine, and all of granules 20, 22, 24 are absent serpentinite. In another non-limiting embodiment, one or more or all of granules 20, 22, 24 are fully or partially formed of serpentinite, and all of granules 20, 22, 24 are absent olivine. In another non-limiting embodiment, some of the granules are formed of olivine and some of the granules are formed of serpentinite. In another non-limiting embodiment, the combined weight percent of granules 20, 22, 24 that are partially or fully formed of olivine and/or serpentinite is 5-100 wt. % (and all values and ranges therebetween), and typically 10-70 wt. %. When the granules include both granules that are formed of or include olivine and granules that are formed of or include serpentinite, the weight ratio of granules that are formed of or include olivine to granules that are formed of or include serpentinite is 0.05:1 to 1:0.05 (and all values and ranges therebetween), and typically 0.2:1 to 1:0.2. The average particle size of the granules that are formed of or include olivine and/or serpentinite can be less, the same, or greater than the average size of the granules that are absent olivine and serpentinite.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

The description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A roofing or siding system that includes a) a roofing and/or siding material, and b) granules; at least a portion of said granules are secured to a top surface of said roofing and/or siding material; at least a portion of said granules are partially or fully formed of olivine and/or serpentinite.

2. The roofing or siding system as defined in claim 1, wherein said roofing and/or siding material includes a) wood base sheet, b) a plastic base sheet, c) a foam base sheet, d) a metal sheet, e) a shingle, f) a cap sheet, g) a modified bitumen membrane, h) a bitumen membrane, i) an asphalt membrane, j) polyurethane layer, k) an asphalt layer, l) a bitumen layer, m) a built-up roofing (BUR) layer, or n) an adhesive layer on a roof or siding substrate.

3. The roofing or siding system as defined in claim 1, wherein said roofing and/or siding material is i) a shingle, ii) a cap sheet, iii) a modified bitumen membrane, iv) a bitumen membrane, or v) an asphalt membrane, said roofing and/or siding material includes a layer of reinforcement material.

4. The roofing or siding system as defined in claim 1, wherein all of said granules a) are fully formed of olivine and/or serpentinite, and/or b) include olivine and/or serpentinite.

5. The roofing or siding system as defined in claim 1, wherein a portion of said granules are formed of or include olivine and/or serpentinite and a portion of said granules are absent olivine and/or serpentinite.

6. The roofing or siding system as defined in claim 5, wherein said granules are a mixture of a) granules fully formed of olivine and/or serpentinite and granules that are partially formed of olivine and/or serpentinite, b) granules fully formed of olivine and/or serpentinite and granules that are formed of materials other than olivine and/or serpentinite, c) granules partially formed of olivine and/or serpentinite and granules that are formed of materials other than olivine and/or serpentinite, or d) granules fully formed of olivine and/or serpentinite, granules that are partially formed of olivine and/or serpentinite, and granules that are formed of materials other than olivine and/or serpentinite.

7. The roofing or siding system as claim 4, wherein said granules that are partially or fully formed of olivine and/or serpentinite are not fully coated with a material that inhibits or prevents CO₂ from being absorbed in said olivine and/or serpentinite.

8. The roofing or siding system as defined in claim 1, wherein said roofing and/or siding system is a flood coat and gravel system; said granules on said flood coat and gravel system are from 1/16 inch to 1 inch in diameter; said granules are broadcast onto an adhesive surface on said top surface of said roofing and/or siding material; said granules are applied to said top surface of said roofing and/or siding material at a coverage of 100-400 lbs./100 square feet.

9. The roofing and/or siding system as defined in claim 1, wherein said granules cover over 50% of said top surface of said roofing and/or siding material.

10. The roofing and/or siding system as defined in claim 1, wherein said top surface of said roofing and/or siding material includes an asphalt and/or bitumen surface; a plurality of said granules are at least partially embedded in said asphalt and/or bitumen surface.

11. A roofing or siding system that includes a) a roofing and/or siding material, and b) granules; at least a portion of said granules are secured to a top surface of said roofing and/or siding material; at least a portion of said granules are partially or fully formed of a CO₂ absorbing mineral material that includes magnesium, iron and silicate.

12. The roofing or siding system as defined in claim 11, wherein said CO₂ absorbing mineral material includes olivine and/or serpentinite.

13. The roofing or siding system as defined in claim 11, wherein said CO₂ absorbing mineral material has an average particle size of 0.2-25 mm.

14. The roofing or siding system as defined in claim 11, wherein said CO₂ absorbing mineral material covers 5-100% of said top surface of said roofing and/or siding material.

15. The roofing or siding system as defined in claim 11, wherein said roofing and/or siding material includes a) wood base sheet, b) a plastic base sheet, c) a foam base sheet, d) a metal sheet, e) a shingle, f) a cap sheet, g) a modified bitumen membrane, h) a bitumen membrane, i) an asphalt membrane, j) polyurethane layer, k) an asphalt layer, l) a bitumen layer, m) a built-up roofing (BUR) layer, or n) an adhesive layer on a roof or siding substrate.

16. The roofing or siding system as defined in claim 11, wherein said roofing and/or siding material is i) a shingle, ii) a cap sheet, iii) a modified bitumen membrane, iv) a bitumen membrane, or v) an asphalt membrane, said roofing and/or siding material includes a layer of reinforcement material.

17. The roofing or siding system as defined in claim 11, wherein all of said granules a) are fully formed of olivine and/or serpentinite, and/or b) include olivine and/or serpentinite.

18. The roofing or siding system as defined in claim 11, wherein a portion of said granules are formed of or include olivine and/or serpentinite and a portion of said granules are absent olivine and/or serpentinite.

19. The roofing or siding system as defined in claim 18, wherein said granules are a mixture of a) granules fully formed of olivine and/or serpentinite and granules that are partially formed of olivine and/or serpentinite, b) granules fully formed of olivine and/or serpentinite and granules that are formed of materials other than olivine and/or serpentinite, c) granules partially formed of olivine and/or serpentinite and granules that are formed of materials other than olivine and/or serpentinite, or d) granules fully formed of olivine and/or serpentinite, granules that are partially formed of olivine and/or serpentinite, and granules that are formed of materials other than olivine and/or serpentinite.

20. The roofing or siding system as claim 17, wherein said granules that are partially or fully formed of olivine and/or serpentinite are not fully coated with a material that inhibits or prevents CO₂ from being absorbed in said olivine and/or serpentinite.

21. The roofing and/or siding system as defined in claim 11, wherein said top surface of said roofing and/or siding material includes an asphalt and/or bitumen surface; a plurality of said granules are at least partially embedded in said asphalt and/or bitumen surface.
